(19) United States
(12) Patent Application Publication
(10) Pub. No.: US 2011/0242505 A1
(43) Pub. Date: Oct. 6, 2011

(54) LIGHT SOURCE DEVICE AND PROJECTOR

(75) Inventors: Yuji Takado, Matsumoto-shi (JP); Takeshi Takezawa, Matsumoto-shi (JP)

(73) Assignee: SEIKO EPSON CORPORATION, Tokyo (JP)

(21) Appl. No.: 13/125,446

(22) PCT Filed: Sep. 17, 2009
(86) PCT No.: PCT/JP2009/004690

§ 371 Date: Apr. 21, 2011

(30) Foreign Application Priority Data
Oct. 30, 2008 (JP) 2008-279332

(51) Int. Cl. G03B 21/28; H01K 1/30

(52) U.S. Cl. 353/98; 313/113

(57) ABSTRACT

A light source device includes an arc tube having a tube spherical portion containing a light emission portion and a pair of sealing portions, a reflector and a sub mirror having a reflecting portion and a fixing portion. The reflector is so shaped that at least an end on one side is removed in a cross-sectional view cut along a predetermined plane containing a revolution center axis. The fixing portion of the sub mirror is so constructed as to cover at least the sealing portion as one of the pair of the sealing portions of the arc tube through an area larger than the half of the outer circumference of the sealing portion.

### TECHNICAL FIELD

The present invention relates to a light source device and a projector.

### BACKGROUND ART

A light source device equipped on a projector is known (for example, see JP-A-2007-335196).

A related-art light source device includes an arc tube which has a tube spherical portion containing a light emission portion and has a pair of sealing portions, a reflector which is so shaped that an end of the reflector on one side is removed in a cross-sectional view cut along a predetermined plane containing a revolution center axis and reflects light emitted from the light emission portion such that the light can travel toward a light receiving area, and a sub mirror which is disposed in such a condition as to cover the one side of the tube spherical portion and has a reflection portion for reflecting light emitted from the light emission portion such that the light can travel toward the light emission portion. The sub mirror further has a fixing portion disposed on the one side of one of the pair of the sealing portions to fix the sub mirror to the corresponding sealing portion. The fixing portion is fixed to the sealing portion by an adhesive. The arc tube is fixed to the reflector by an adhesive.

Accordingly, the related-art light source device which achieves reduction of its thickness by removing the end of the reflector on the one side effectively uses light emitted from the light emission portion by providing the sub mirror disposed in such a manner as to cover the one side of the tube spherical portion. In this case, the thickness of the light source device can be decreased without lowering luminance. Moreover, a high-luminance and thin type projector can be manufactured by equipping the light source device thus constructed on the projector.

### SUMMARY OF INVENTION

### Problems that the Invention is to Solve

However, investigations performed by the inventors of the invention show that problems such as easy drop of the sub mirror from the sealing portion and low shock resistance arise from the related-art light source device.

Accordingly, the invention has been developed to solve these problems. It is an object of the invention to provide a light source device which achieves reduction of its thickness without lowering luminance, and further has high shock resistance. It is another object of the invention to provide a projector which includes this light source device to achieve luminance increase and thickness reduction of the projector and have high shock resistance.

### Means for Solving the Problems

A light source device according to the invention is characterized by including: an arc tube which has a tube spherical portion containing a light emission portion and has a pair of sealing portions: a reflector which is so shaped that at least an end on one side is removed in a cross-sectional view cut along a predetermined plane containing a revolution center axis and reflects light emitted from the light emission portion such that the light can travel toward a light receiving area and a sub mirror which is disposed in such a condition as to cover the one side of the tube spherical portion and has a reflection portion for reflecting light emitted from the light emission portion such that the light can travel toward the light emission portion. The sub mirror further has a fixing portion for fixing the sub mirror to the sealing portion by using an adhesive. The fixing portion is so constructed as to cover at least one of the pair of the sealing portions through an area larger than the half of the outer circumference of the corresponding sealing portion.

According to the light source device of the invention, therefore, the thickness of the light source device can be reduced by removing the end of the reflector on the one side. Also, the light emitted from the light emission portion can be effectively used by disposing the sub mirror in such a condition as to cover the one side of the tube spherical portion. Thus, reduction of the thickness can be achieved without lowering luminance. Moreover, according to the light source device of the invention, the fixing portion so constructed as to cover the sealing portion through an area larger than the half of the outer circumference of the sealing portion is provided. In this case, the sub mirror can be strongly fixed to the arc tube by a large bonding area sufficient for covering the sealing portion. Thus, the sub mirror does not easily drop from the sealing portion, which increases shock resistance. Accordingly, the light source device of the invention can achieve reduction of its thickness without lowering luminance, and further has high shock resistance.

It is preferable that the fixing portion is fixed to the sealing portion by cement in the light source device of the invention.

According to the light source device of the invention, the sub mirror can be strongly fixed to the arc tube by a large bonding area sufficient for covering the sealing portion. In this case, the sub mirror can be fixed by a sufficient force given by the cement having only a small bonding force as described above. Thus, the sub mirror can be fixed to the sealing portion without using a strong alkaline adhesive having a large bonding force but having high corrosiveness. Accordingly, the life of the light source device can be lengthened.

It is preferable that a section of the fixing portion is fixed to the reflector by cement in the light source device of the invention.

According to this structure, the sub mirror and the arc tube as one body can be fixed to the reflector. Thus, the shock resistance of the light source device increases.

It is preferable that the fixing portion is so constructed that the length of the fixing portion in the longitudinal direction of the sealing portion gradually decreases from the one side to the other side in the light source device of the invention.

According to this structure, the sub mirror can be fixed to the arc tube with the lowest possibility of blocking light emitted from the light emission portion toward the reflector.

It is preferable that the fixing portion covers the entire outer circumference of the sealing portion in the light source device of the invention.

According to this structure, the sub mirror can be strongly fixed to the arc tube by a large bonding area sufficient for covering the entire area of the sealing portion. Thus, the shock resistance further increases.

It is preferable that the inner surface of the reflection portion has an aspherical shape and is so constructed that the light reflected by the reflection portion can travel toward the light emission portion in the light source device of the invention.

According to this structure, the light released from the sub mirror can be reflected toward the center of the arc tube. Thus, the light emitted from the light emission portion can be used further effectively.

A projector according to the invention includes: an illumination device which includes the light source device according to the invention; an electro-optic modulation device which modulates illumination light emitted from the illumination device according to image information; and a projection lens which projects modulation light received from the electro-optic modulation device.

According to the projector of the invention, therefore, the light source device of the invention which achieves thickness reduction without lowering luminance and further has high shock resistance is equipped. Thus, the projector becomes a high-luminance and thin type and also highly shock-resistant projector.

### BRIEF DESCRIPTION OF THE DRAWINGS

FIG. 1 illustrates a light source device 10 according to an embodiment 1.

FIG. 2 illustrates a sub mirror 40 included in the light source device 10 according to the embodiment 1.

FIG. 3 illustrates a method for manufacturing the sub mirror 40 included in the light source device 10 according to the embodiment 1.

FIG. 4 illustrates a projector 1000 according to the embodiment 1.

FIG. 5 illustrates an illumination device 100 according to the embodiment 1.

FIG. 6 illustrates the main part of a light source device 10a according to a modified example 1.

FIG. 7 illustrates a light source device 10b according to a modified example 2.

FIG. 8 illustrates a light source device 10c according to a modified example 3.

FIG. 9 illustrates a light source device 10d according to a modified example 4.

### BEST MODE FOR CARRYING OUT THE INVENTION

A light source device and a projector according to the invention are hereinafter described based on an embodiment shown in the drawings.

### Embodiment 1

### 1. Structure of Light Source Device 10

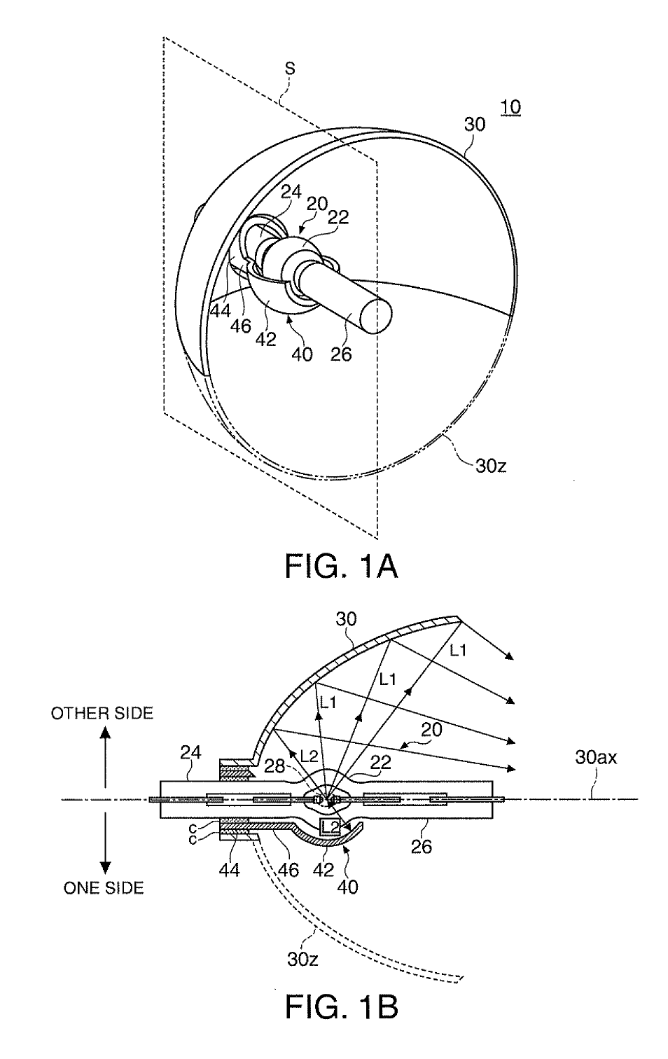

FIG. 1 illustrates a light source device 10 according to an embodiment 1. FIG. 1(a) is a perspective view of the light source device 10, while FIG. 1(b) is a vertical cross-sectional view of the light source device 10.

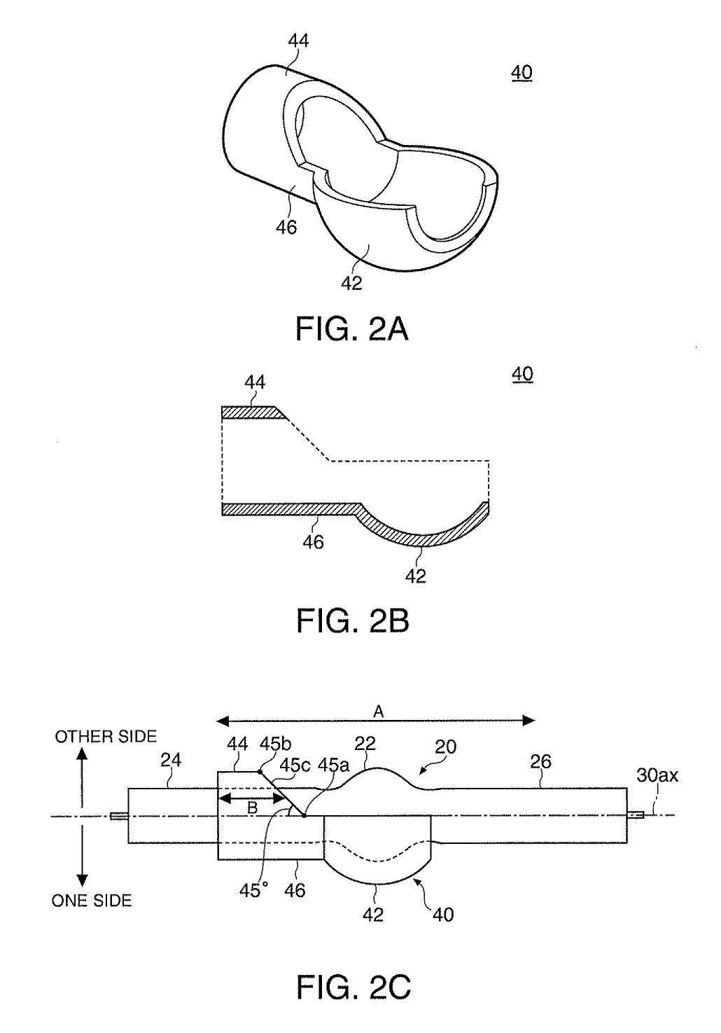

FIG. 2 illustrates a sub mirror 40 included in the light source device 10, according to the embodiment 1. FIG. 2(a) is a perspective view of the sub mirror 40. FIG. 2(b) is a vertical cross-sectional view of the sub mirror 40. FIG. 2(c) is a side view illustrating the sub mirror 40 fixed to an arc tube 20.

As illustrated in FIG. 1, the light source device 10 in the embodiment 1 includes: the arc tube 20 which has a tube spherical portion 22 containing a light emission portion 28, and has a pair of sealing portions 24 and 26; a reflector 30 which is so shaped that an end 30z of the reflector 30 on one side is removed in a cross-sectional view cut along a predetermined plane S containing a revolution center axis 30ax, and reflects light L1 emitted from the light emission portion 28 such that the light L1 can travel toward light receiving areas; and the sub mirror 40 which is disposed in such a condition as to cover the one side of the tube spherical portion 22, and has a reflection portion 42 for reflecting light L2 emitted from the light emission portion 28 such that the light L2 can travel toward the light emission portion 28.

As illustrated in FIGS. 1 and 2, the sub mirror 40 further has a fixing portion 44 for fixing the sub mirror 40 to the sealing portion 24. The fixing portion 44 is fixed to the sealing portion 24 by cement c The fixing portion 44 is fixed to the reflector 30 by the cement c. The fixing portion 44 is so constructed as to cover the entire part of the outer circumference of the sealing portion 24. As illustrated in FIG. 2(c), the fixing portion 44 is so constructed that a length B of the fixing portion 44 extending in a longitudinal direction A of the sealing portion 24 gradually decreases from the one side to the other side. The angle formed by a line 45c connecting a root end portion 45a and a tip portion 45b of the fixing portion 44 and an axis extending in the longitudinal direction A of the light emission portion 28 is 45°, for example.

The inner surface of the reflection portion 42 has an aspherical shape so constructed as to reflect the light L2 reflected by the reflection portion 42 such that the light L2 can travel toward the light emission portion 28. The reflector 30 has a spheroidal reflection surface, for example. The sub mirror 40 is made of quartz glass, for example.

### 2. Light Source Device Manufacturing Method

A method for manufacturing the light source device is now explained. The arc tube 20, the reflector 30, and the sub mirror 40 are prepared beforehand. Initially, the sub mirror 40 of these components is fixed to the arc tube 20, and the arc tube 20 is fixed to the reflector 30 at the position of the fixing portion 44 of the sub mirror 40. Since the methods for manufacturing the arc tube 20 and the reflector 30 are well known, only the method for manufacturing the sub mirror 40 is herein explained in detail.

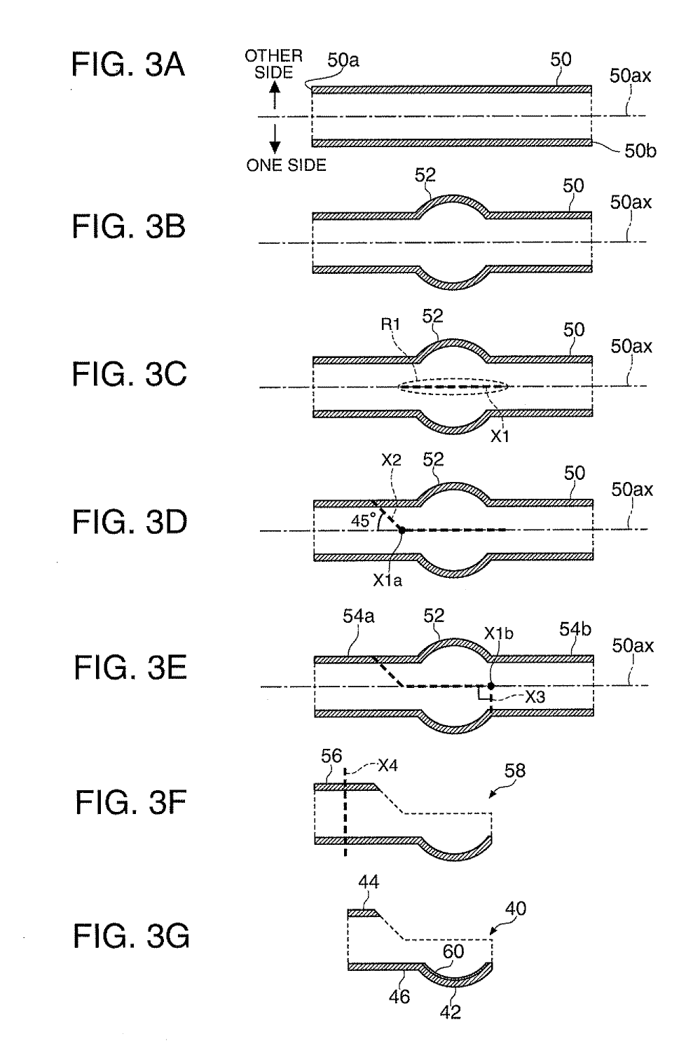

FIG. 3 illustrates the method for manufacturing the sub mirror 40 included in the light source device 10 according to the embodiment 1. FIGS. 3(a) through 3(g) show respective steps. FIG. 3 does not show cutting margins produced during the actual cutting processes.

### (1) Tube-shaped Member Preparation Step

Initially, a tube-shaped member 50 sized to have an inside diameter corresponding to the inside diameter of the fixing portion 44 (see FIG. 3(g)) is prepared (see FIG. 3(a)). The tube-shaped member 50 is made of hard glass or quartz glass as a preferable example. Among these materials, quartz glass is more preferable because quartz glass which has a low coefficient of thermal expansion and does not leave internal distortion requires no annealing process. The tube-shaped member 50 has a tube-shaped portion 50a on the side where the fixing portion 44 is formed and a tube-shaped portion 50b on the opposite side as separate portions even having no difference in appearance in this step for convenience of explanation.

### (2) Expanded Portion Forming Step

Next, the tube-shaped member 50 is heated and inserted into a mold (not shown). Then, internal pressure is applied to the tube-shaped member 50 by using inert gas to expand the tube-shaped member 50 into such a shape that a part of the inner surface shape of the tube-shaped member 50 becomes a predetermined shape as an expanded portion 52 (see FIG. 3(b)) in correspondence with the reflection portion 42. The inert gas is constituted by argon gas or nitrogen gas as a preferable example.

### (3) Cutting Step

### (3-1) First Cutting Step

Next, a cut X1 is formed on a region R1 containing the expanded portion 52 along a plane containing an axis 50ax of the tube-shaped member 50 by using a slicer (see FIG. 3(c)). While FIG. 3(c) shows only one line of the cut X1, the cut X1 is actually formed on each of the sheet front surface side and the sheet back surface side of the expanded portion 52 (two lines in total).

### (3-2) Second Cutting Step

Next, a cut X2 is formed from the other side toward a tube-shaped portion 50a side end X1a of the cut X1 in a diagonal direction (45°) (see FIG. 3(d)). In this case, the cut X2 becomes one line cut continuing from the sheet front surface side to the sheet back surface side (the same is true for cuts X3 and X4 described later).

### (3-3) Third Cutting Step

Next, the cut X3 is formed from the one side toward a tube-shaped portion 50b side end X1b of the cut X1 in the right-angled direction (see FIG. 3(e)). After the third cutting step is finished, the tube-shaped member 50 is separated into two cut pieces 54a and 54b. Thus, the processing for the cut piece 54a is hereinafter carried out in the following steps.

### (3-4) Fourth Cutting Step

Next, an end portion 56 of the tube-shaped portion 50a is separated from the cut piece 54a by forming the cut X4 to produce the fixing portion 44 (see FIG. 3(f)). A sub mirror base material 58 is now completed after the finish of the cutting steps.

### (4) Reflection Layer Forming Step

Next, a reflection layer 60 is formed on the inner surface of the expanded portion 52 (see FIG. 3(g)). The reflection layer 60 is formed by a dielectric multilayer film made of tantalum oxide (Ta₂O₅) and silicon oxide (SiO₂) as a preferable example. The sub mirror 40 is completed after the finish of the reflection layer forming step.

Then, the sub mirror 40 thus manufactured is fixed to the arc tube 20 at the fixing portion 44, and simultaneously the arc tube 20 is fixed to the reflector at the fixing portion 44. By this step, the light source device 10 is completed.

### 3. Structure of Projector

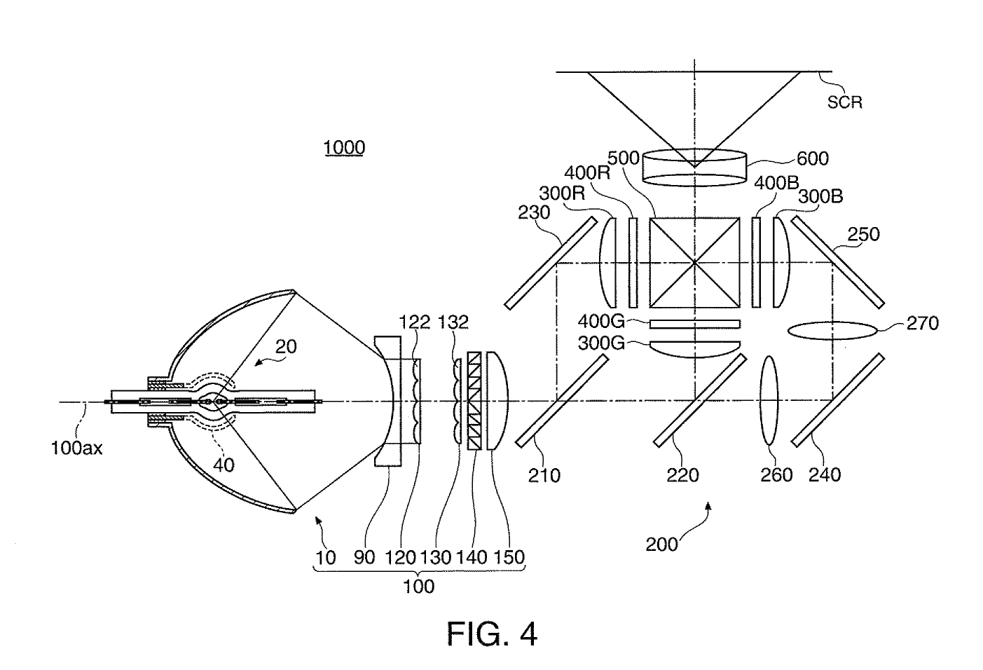

FIG. 4 illustrates an optical system of a projector 1000 according to the embodiment 1.

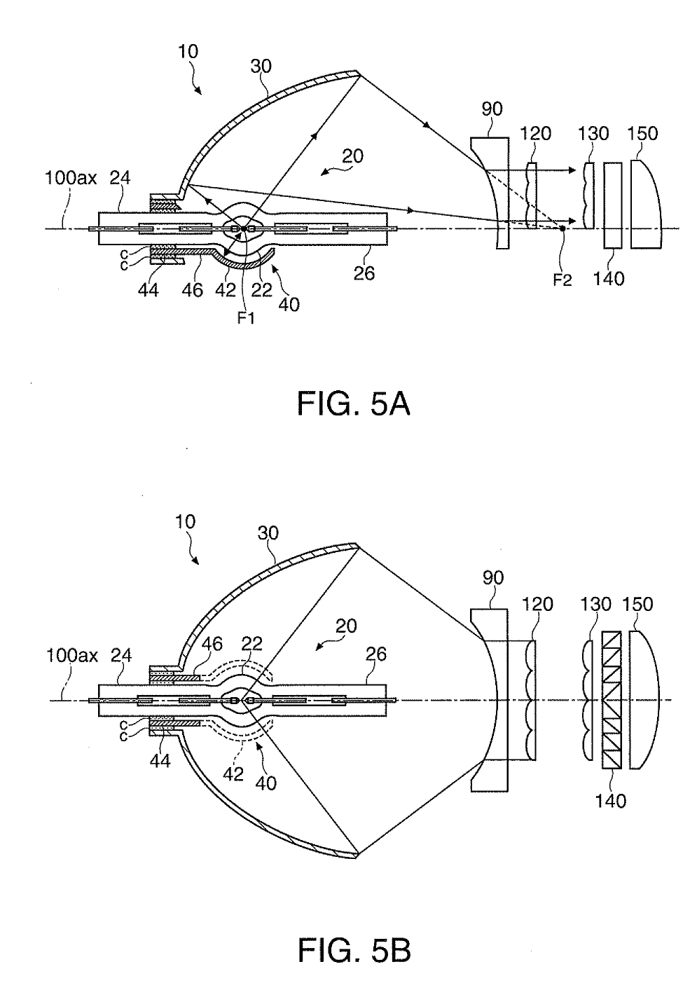

FIG. 5 illustrates an illumination device 100. FIG. 5(a) is a vertical cross-sectional view of the illumination device 100, while FIG. 5(b) is a horizontal cross-sectional view of the illumination device 100.

As illustrated in FIG. 4, the projector 1000 according to the embodiment 1 includes: the illumination device 100; a color separation light guide system 200 which separates illumination light received from the illumination device 100 into three color lights of red light, green light, and blue light, and guides the separated color lights toward the light receiving areas; three liquid crystal devices 400R, 400G, and 400B as electro-optic modulation devices for modulating the three color lights separated by the color separation light guide system 200 according to image information; a cross dichroic prism 500 which combines the color lights modulated by the three liquid crystal devices 400R, 400G, and 400B; and a projection lens 600 which projects the light combined by the cross dichroic prism 500 onto a projection surface such as a screen SCR.

As illustrated in FIGS. 4 and 5, the illumination device 100 has the light source device 10 which emits illumination light toward the light receiving areas, a concave lens 90 which receives converged light from the light source device 10 and releases the light as substantially collimated light, a first lens array 120 which has a plurality of first small lenses 122 for dividing the illumination light received from the concave lens 90 into a plurality of partial lights, a second lens array 130 which has a plurality of second small lenses 132 corresponding to the plural first small lenses of the first lens array 120, a polarization converting element 140 which converts the respective partial lights received from the second lens array 130 into substantially one type of linearly polarized lights having the same polarization direction, and a stacking lens 150 which stacks the respective partial lights received from the polarization converting element 140 on the light receiving areas.

As illustrated in FIGS. 4 and 5, the light source device 10 according to the embodiment 1 has the ellipsoidal reflector 30 as a reflector, the arc tube 20 which has the light emission center in the vicinity of a first focus of the ellipsoidal reflector 30, and the sub mirror 40 as reflection means. The light source device 10 emits light having an illumination optical axis 100ax as the center axis.

As illustrated in FIG. 5, the arc tube 20 includes the tube spherical portion 22 which contains a pair of electrodes disposed along the illumination optical axis 100ax, a pair of the sealing portions 24 and 26 extending from both sides of the tube spherical portion 22, a pair of metal foils each of which is sealed into the corresponding one of the pair of the sealing portions 24 and 26, and a pair of leads each of which is electrically connected with the corresponding one of the pair of the metal foils. The outer surface of the tube spherical portion 22 is smoothly connected with the outer surfaces of the pair of the sealing portions 24 and 26. When voltage is applied to the leads, a potential difference is produced between the pair of the electrodes to generate discharge and an arc image is produced. This arc image corresponds to the light emission portion.

The conditions of the constituent elements of the arc tube 20 and the like are herein listed as examples. The tube spherical portion 22 and the sealing portions 24 and 26 are made of quartz glass, for example mercury, rare gas, and a small quantity of halogen are sealed into the tube spherical portion 22. The electrodes are formed by tungsten electrodes, for example. The metal foils are formed by molybdenum foils, for example. The leads are made of molybdenum or tungsten, for example.

The arc tube 20 is selected from various types of arc tubes emitting high-luminance light. For example, a high-pressure mercury lamp, an extra-high pressure mercury lamp, or a metal halide lamp can be employed.

As illustrated in FIG. 5, the ellipsoidal reflector 30 has an opening through which the sealing portion 24 of the arc tube 20 is inserted to be fixed thereto, and a reflection surface which reflects light emitted from the arc tube 20 such that the light can travel toward a second focus. The ellipsoidal reflector 30 is fixed to the arc tube 20 on the sealing portion 24 side by the cement c injected into the opening of the ellipsoidal reflector 30.

Preferable examples of the base material of the reflection surface are crystalized glass and alumina (Al₂O₃). A visible light reflection layer formed by a dielectric multilayer film made of titanium oxide (TiO₂) and silicon oxide (SiO₂), for example, is provided on the inner surface of the reflection surface.

As described above, the sub mirror 40 is disposed in such a condition as to cover the one side of the tube spherical portion 22, and has the reflection portion 42 which reflects the light L2 emitted from the light emission portion 28 such that the light L2 can travel toward the light emission portion 28, and the fixing portion 44 which fixes the sub mirror 40 to the sealing portion 24. The sub mirror 40 is a component manufactured by the sub mirror manufacturing method described above.

As illustrated in FIG. 5, the concave lens 90 is disposed at a position shifted from the ellipsoidal reflector 30 toward the light receiving areas. The concave lens 90 is so structured as to receive light from the ellipsoidal reflector 30 and release the light toward the first lens array 120.

The first lens array 120 functions as a light dividing element which divides light received from the concave lens 90 into a plurality of partial lights. The first lens array 120 has the plural first small lenses 122 disposed in matrix on the plane perpendicular to the illumination optical axis 100ax. Though not shown in the figure, each external shape of the first small lenses 122 is a shape similar to each external shape of the light receiving areas of the liquid crystal devices 400R, 400G, and 400B.

The second lens array 130 is an optical element which converges the plural partial lights divided by the first lens array 120 described above, and has the plural second small lenses 132 disposed in matrix within the plane perpendicular to the illumination optical axis 100ax similarly to the first lens array 120.

The polarization converting element 140 is a polarization converting element which converts the polarization directions of the respective partial lights divided by the first lens array 120 into substantially one type of linearly polarized lights having the same polarization direction and releases the converted lights.

The polarization converting element 140 includes: a polarization separation layer which transmits one of the linearly polarized components contained in the light emitted from the light source device 10 without change, and reflects the other linearly polarized component in the direction perpendicular to the illumination optical axis 100ax; a reflection layer which reflects the other linearly polarized component reflected by the polarization separation layer such that this component can travel in the direction parallel with the illumination optical axis 100ax; and a retardation film which converts the other linearly polarized component reflected by the reflection layer into the one linearly polarized component.

The stacking lens 150 is an optical element which converges the plural partial lights having passed through the first lens array 120, the second lens array 130, and the polarization converting element 140 and stacks the partial lights in the vicinity of the image forming areas of the liquid crystal devices 400R, 400G, and 400B. While the stacking lens 150 shown in FIG. 4 is constituted by one lens, the stacking lens 150 may be formed by a combination of plural lenses.

As illustrated in FIG. 4, the color separation light guide system 200 includes dichroic mirrors 210 and 220, reflection mirrors 230, 240, and 250, and entrance side lens 260 and relay lenses 270. The color separation light guide system 200 has functions of separating illumination light emitted from the illumination device 100 into three color lights of red light, green light, and blue light, and guiding the respective color lights toward the liquid crystal devices 400R, 400G, and 4008 as illumination targets.

The dichroic mirrors 210 and 220 are optical elements each of which has a wavelength selection film for reflecting light having a predetermined wavelength range onto a substrate and transmitting light having the other wavelength range. The dichroic mirror 210 disposed on the optical path upstream side is a mirror which reflects the red light component and transmits the other color light components. The dichroic mirror 220 disposed on the optical path downstream side is a mirror which reflects the green light component and transmits the blue light component.

The red light component reflected by the dichroic mirror 210 is bended by the reflection mirror 230 and reaches the image forming area of the liquid crystal device 400R for red light via a converging lens 300R.

The converging lens 300R is provided to convert the respective partial lights received from the stacking lens 150 into lights substantially parallel with the chief rays. Converging lenses 300G and 300B provided on the upstream side of the other liquid crystal devices 400G and 400E have structure similar to that of the converging lens 300R.

The green light component as one of the pair of the green and blue light components having passed through the dichroic mirror 210 is reflected by the dichroic mirror 220, and reaches the image forming area of the liquid crystal device 400G for green light via the converging lens 300G. On the other hand, the blue light component passes through the dichroic mirror 220, and further passes through the entrance side lens 260, the entrance side reflection mirror 240, the relay lens 270, the exit side reflection mirror 250, and the converging lens 300B to reach the image forming area of the liquid crystal device 400E for blue light. The entrance side lens 260, the relay lens 270, and the reflection mirrors 240 and 250 have a function of guiding the blue light component having passed through the dichroic mirror 220 toward the liquid crystal device 400B.

The entrance side lens 260, the relay lens 270, and the reflection mirrors 240 and 250 are provided on the optical path of the blue light so as to prevent decrease in the efficiency of using the blue light caused by divergence or the like of the blue light which has a larger optical path length than those of the other color lights. The projector 1000 in the embodiment 1 has this structure since the optical path of the blue light is long. However, such a structure which has a longer optical path for the red light and uses the entrance side lens 260, the relay lens 270, and the reflection mirrors 240 and 250 for the optical path of the red light is allowed.

The liquid crystal devices 400R, 400G, and 400B which modulate received illumination light according to image information are illumination targets for the illumination device 100. An entrance side polarization plate is provided between each pair of the converging lens 300R and the liquid crystal device 400R, the converging lens 300G and the liquid crystal device 400G, and the converging lens 300B and the liquid crystal device 400B. Similarly, an exit side polarization plate is provided between each pair of the liquid crystal device 400R and the cross dichroic prim 500, the liquid crystal device 400G and the cross dichroic prism 500, and the liquid crystal device 400B and the cross dichroic prism 500. These entrance side polarization plates and exit side polarization plates are not shown in the figures. The entrance side polarization plates, the liquid crystal devices 400R, 400G, and 400B, and the exit side polarization plates modulate the respective received color lights.

Each of the liquid crystal devices 400R, 400G, and 400B has a pair of transparent glass bases into which liquid crystals as electro-optic substances are sealed, and modulates the polarization direction of the one type linearly polarized lights received from the entrance side polarization plate according to a received image signal by using polysilicon TFT as switching elements, for example.

The cross dichroic prism 500 is an optical element which combines optical images modulated for each of the color lights received from the exit side polarization plates to form a color image. The cross dichroic prism 500 has a substantially square shape in the plan view produced by affixing four rectangular prisms, and has dielectric multilayer films on the interfaces of the rectangular prisms affixed to each other substantially in an X shape. The dielectric multilayer film formed on one of the substantially X-shaped interfaces reflects red light, and the dielectric multilayer film formed on the other interface reflects blue light. The red light and the blue light are bended by these dielectric multilayer films such that the traveling directions of the red light and the blue light can be equalized with the traveling direction of the green light. As a result, the three color lights are combined.

The color image released from the cross dichroic prism 500 is expanded and projected by the projection lens 600 to be displayed as an image on the screen SCR.

As described above, the light source device 10 in the embodiment 1 is a light source device which has the arc tube 20, the reflector 30, and the sub mirror 40. The projector 1000 in the embodiment 1 is a projector which includes the illumination device 100 having the light source device 10 in the embodiment 1.

Accordingly, the light source device 10 in the embodiment 1 can reduce its thickness by removing the end 30z of the reflector 30 on the one side, and also can effectively use light emitted from the light emission portion 28 by providing the sub mirror 40 in such a condition as to cover the tube spherical portion 22 on the one side. According to this structure, reduction of the thickness can be achieved without lowering luminance. Moreover, the light source device 10 in the embodiment 1 has the fixing portion 44 so structured as to cover the entire outer circumference of the sealing portion 24. In this case, the sub mirror 40 can be strongly fixed to the arc tube 20 by a large bonding area sufficient for covering the sealing portion 24. Thus, the sub mirror 40 does not easily drop from the sealing portion 24, which increases shock resistance. Accordingly, the light source device 10 in the embodiment 1 becomes a light source device which can reduce its thickness without lowering luminance, and can increase shock resistance.

Moreover, according to the light source device 10 in the embodiment 1, the sub mirror 40 can be strongly fixed to the arc tube 20 by a large bonding area sufficient for covering the sealing portion 24. In this case, the sub mirror 40 can be fixed to the sealing portion 24 by a sufficient fixing force given by the cement c having only a small bonding force as described above. Thus, the sub mirror can be fixed to the sealing portion without using a strong alkaline adhesive having a large bonding force but having high corrosiveness. Accordingly, the life of the light source device can be lengthened.

Furthermore, according to the light source device 10 in the embodiment 1, the fixing portion 44 is fixed to the reflector 30 by using the cement c. In this case, the sub mirror 40 and the arc tube 20 as one body can be fixed to the reflector 30. Thus, the shock resistance of the light source device increases.

Furthermore, according to the light source device 10 in the embodiment 1, the fixing portion 44 is constructed such that the length B of the fixing portion 44 in the longitudinal direction A of the sealing portion gradually decreases from the one side to the other side. Thus, the sub mirror 40 can be fixed to the arc tube 20 with the lowest possibility of blocking light emitted from the light emission portion 28 toward the reflector 30.

Furthermore, according to the light source device 10 in the embodiment 1, the inner surface of the reflection portion 42 has an aspherical shape, and is so structured as to reflect light reflected by the reflection portion such that the light can travel toward the light emission portion 28. Thus, the light released from the sub mirror 40 can be reflected toward the center of the arc tube 20, which allows light emitted from the light emission portion 28 to be highly effectively used.

The projector 1000 in the embodiment 1 includes the illumination device 100 having the light source device 10 in the embodiment 1, the liquid crystal devices 400R, 400G, and 400B as the electro-optic modulation devices for modulating illumination light emitted from the illumination device 100 according to image information, and the projection lens 600 for projecting the modulated lights received from the liquid crystal devices 400R, 400G, and 400B. According to this structure, the projector 1000 contains the light source device 10 of the invention which can achieve thickness reduction without lowering luminance and can increase shock resistance. Thus, the projector 1000 becomes a high-luminance and thin type and also high shock-resistance type projector.

### MODIFIED EXAMPLE 1

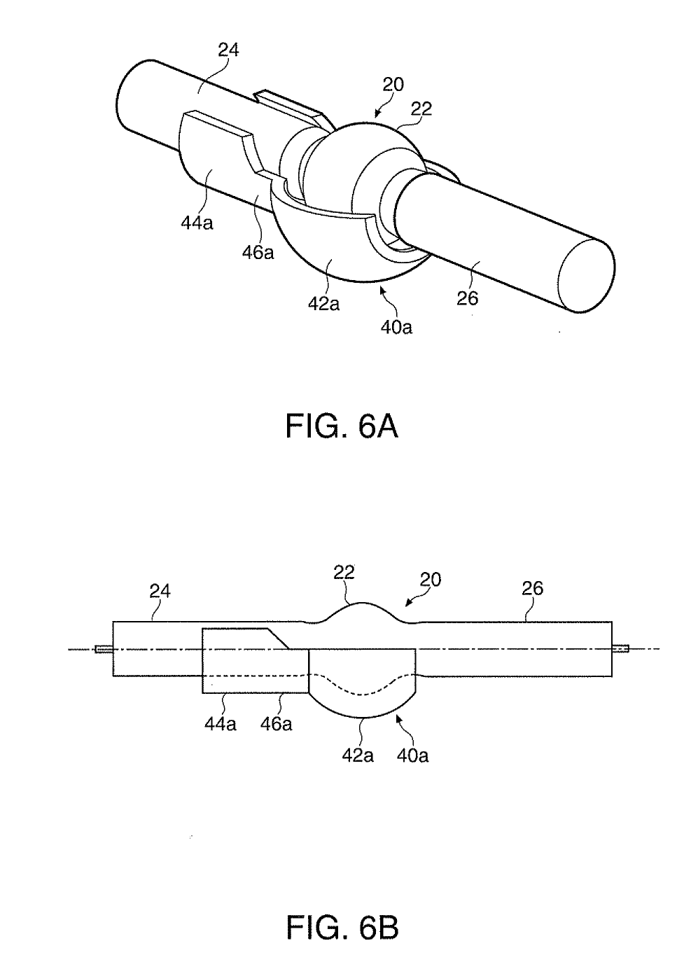

FIG. 6 illustrates the main part of a light source device 10a according to a modified example 1. FIG. 6(a) is a perspective view showing the arc tube 20 to which a sub mirror 40a is attached, while FIG. 6(b) is a side view showing the arc tube 20 to which the sub mirror 40a is attached.

The light source device 10a in the modified example 1 basically has structure similar to that of the light source device 10 in the embodiment 1 However, the structure of the sub mirror is different from that of the light source device 10 in the embodiment 1. More specifically, as illustrated in FIG. 6, the sub mirror 40a of the light source device 10a in the modified example 1 has a fixing portion 44a which covers an area of the sealing portion 24 larger than the half of the outer circumference of the sealing portion 24 but does not cover the entire circumference.

Accordingly, the light source device 10a in the modified example 1 has the fixing portion 44a which has structure different from that of the corresponding component of the light source device 10 in the embodiment 1 but covers the area of the sealing portion 24 larger than the half of the outer circumference of the sealing portion 24 similarly to the structure of the light source device 10 in the embodiment 1. In this case, the sub mirror can be strongly fixed to the tube spherical portion by a large bonding area sufficient for covering the sealing portion. Thus, the sub mirror does not easily drop from the sealing portion, which increases shock resistance.

### MODIFIED EXAMPLE 2

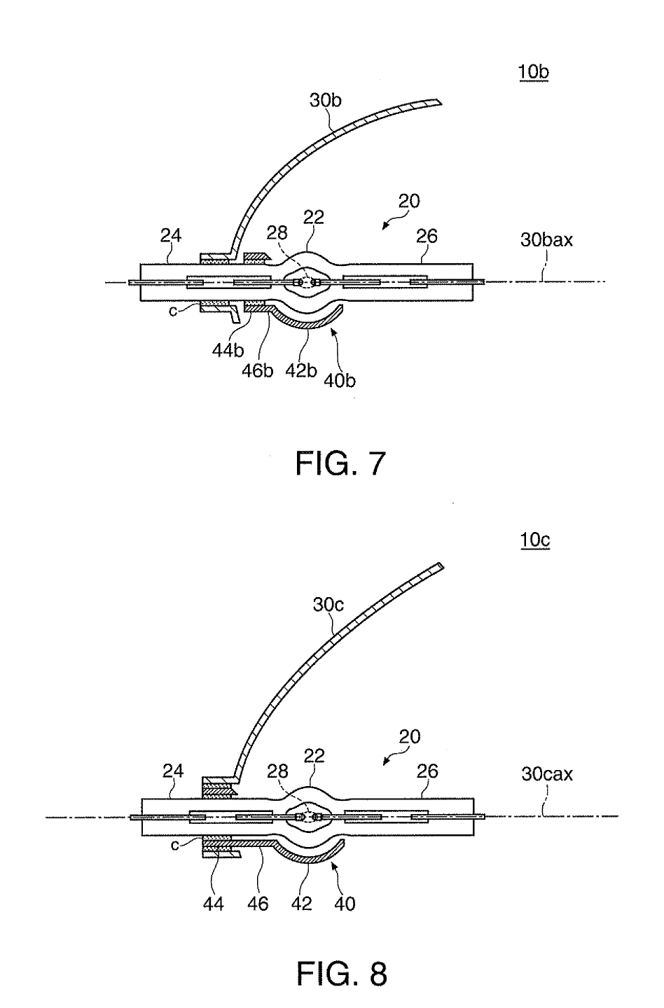

FIG. 7 is a vertical cross-sectional view of a light source device 10b according to a modified example 2.

The light source device 10b in the modified example basically has structure similar to that of the light source device 10 in the embodiment 1. However, the fixing structure for fixing the arc tube to the reflector is different from the corresponding structure of the light source device 10 in the embodiment 1. More specifically, the light source device 10b in the modified example 2 has a fixing structure for directly fixing the sealing portion 24 of the arc tube 20 to a reflector 30b as illustrated in FIG. 7.

Accordingly, the fixing structure for fixing the arc tube to the reflector in the light source device 10b in the modified example 2 is different from the corresponding structure of the light source device 10 in the embodiment 1. However, similarly to the light source device 10 in the embodiment 1, a fixing portion 44b so structured as to cover an area of the sealing portion 24 larger than the half of the outer circumference of the sealing portion 24. In this case, the sub mirror can be strongly fixed to the arc tube by a large bonding area sufficient for covering the sealing portion. Thus, the sub mirror does not easily drop from the sealing portion, which increases shock resistance.

### MODIFIED EXAMPLE 3

FIG. 8 is a vertical cross-sectional view of a light source device 10c according to a third embodiment.

The light source device 10c in the modified example 3 basically has structure similar to that of the light source device 10 in the embodiment 1. However, the type of the reflector is different from the corresponding type of the light source device 10 in the embodiment 1. More specifically, as illustrated in FIG. 8, the light source device 10c in the modified example 3 has a parabolic reflector 30c as the reflector.

According to the light source device 10c in the modified example 3, therefore, the type of the reflector is different from the corresponding type included in the light source device 10 in the embodiment 1. However, a fixing portion 44c so structured as to cover an area of the sealing portion 24 larger than the half of the outer circumference of the sealing portion 24 is provided similarly to the light source device in the embodiment 1. In this case, the sub mirror can be strongly fixed to the arc tube by a large bonding area sufficient for covering the sealing portion. Thus, the sub mirror does not easily drop from the sealing portion, which increases shock resistance.

### MODIFIED EXAMPLE 4

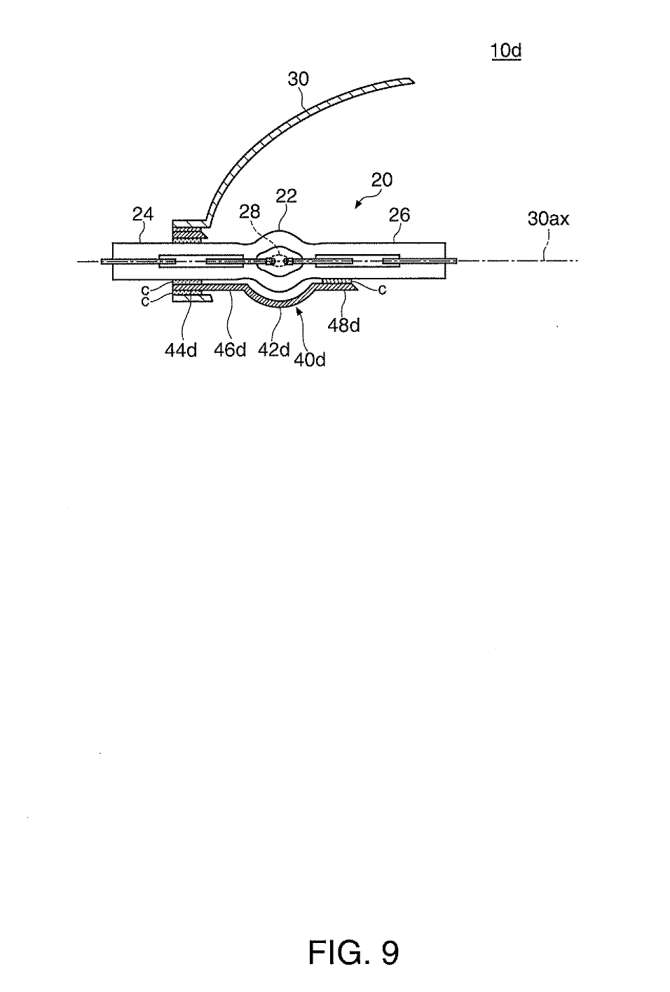

FIG. 9 is a vertical cross-sectional view of a light source device 10d in a modified example 4.

The light source device 10d in the modified example 4 basically has structure similar to that of the light source device 10 in the embodiment 1 However, the structure of the sub mirror is different from the sub mirror of the light source device 10 in the embodiment 1. More specifically, according to the light source device 10d in the modified example 4, the sub mirror 40d has an extended portion 48d on the side opposite to a fixing portion 44d.

Accordingly, the structure of the sub mirror included in the light source device 10d in the modified example 4 is different from the corresponding structure of the light source device 10 in the embodiment However, the fixing portion 44d so structured as to cover an area of the sealing portion 24 larger than the half of the outer circumference of the sealing portion 24 is provided similarly to the light source device 10 in the embodiment 1. Moreover, the extended portion 48d fixed to the sealing portion 26 by the cement c is formed. In this case, the sub mirror can be strongly fixed to the arc tube by a still larger bonding area. Thus, the sub mirror does not easily drop from the sealing portion, which increases shock resistance.

The invention is not limited to the light source device and the projector according to the embodiment described herein but may be practiced otherwise without departing from the scope of the invention. For example, the following modifications may be made.

(1) According to this embodiment, cement is used as an adhesive. However, the invention is not limited to this case. For example, a ceramic heat-resistant adhesive may be employed as an adhesive.

(2) According to this embodiment, the sub mirror which has the fixing portion constructed such that the length of the fixing portion in the longitudinal direction of the sealing portion gradually decreases from the one side to the other side is used. However, the invention is not limited to this case. For example, a sub mirror which has a fixing portion constructed such that the length of the fixing portion in the longitudinal direction of the sealing portion is uniform from the one side to the other side may be employed.

(3) According to this embodiment, the sub mirror which has the fixing portion so constructed as to cover at least one of the pair of the sealing portions through an area larger than the half of the outer circumference of the corresponding sealing portion. However, the invention is not limited to this case. For example, a sub mirror which has a fixing portion so constructed as to cover both of the sealing portions through areas each of which is larger than the half of the outer circumference of the sealing portion may be employed.

(4) According to this embodiment, the sub mirror made of quartz glass is used. However, the invention is not limited to this case. For example, a sub mirror made of metal may be employed.

(5) According to this embodiment, the cutting steps are sequentially performed in the order from the first cutting step to the fourth cutting step. However, the invention is not limited to this case. For example, the order of the second cutting step and the third cutting step may be switched. Alternatively, the fourth step may be initially executed.

(6) According to this embodiment, the case in which the revolution center axis of the reflector extends in parallel with the longitudinal direction of the arc tube has been discussed in the description of the invention. However, the invention is not limited to this case. For example, the invention is applicable to a structure in which the revolution center axis of the reflector and the longitudinal direction of the arc tube are not parallel with each other.

(7) According to this embodiment, the projector which includes the light source device according to the invention has been discussed. However, the invention is not limited to this case. For example, the light source device according to the invention may be included in other optical devices (such as an optical disk device).

(8) According to this embodiment, the lens integrator system which has the first lens array and the second lens array is used as the light equalizing system of the projector. However, the invention is not limited to this case. For example, a rod integrator system which has a light guide rod may be employed.

(9) According to this embodiment, the projector is a transmission type projector. However, the invention is not limited to this case. For example, the projector may be a reflection type projector. The “transmission type” herein refers to a type in which an electro-optic modulation device as light modulation means transmits light such as a transmission type liquid crystal device. The “reflection type” refers to a type in which an electro-optic modulation device as light modulation means reflects light such as a reflection type liquid crystal device. Advantages similar to those of the transmission type projector can be provided when the invention is applied to the reflection type projector.

(10) According to this embodiment, the projector which includes the three liquid crystal devices has been discussed as an example. However, the invention is not limited to this case. For example, the invention is applicable to a projector which has one, two, four, or more liquid crystal devices.

(11) According to this embodiment, the liquid crystal devices are used as the electro-optic modulation devices of the projector. However, the invention is not limited to this case. Generally, any types of the electro-optic device may be used as long as they can modulate received light according to image information. For example, a micromirror type light modulation device may be selected. The micromirror type light modulation device may be a DMD (digital micromirror device)(trademark of TI Inc.), for example.

(12) The invention is applicable to both a front projection type projector which projects a projection image from the image viewing side, and a rear projection type projector which projects a projection image from the side opposite to the image viewing side.

### DESCRIPTION OF REFERENCE NUMERALS AND SIGNS

10, 10a, 10b, 10c, 10d . . . light source device, 20 . . . arc tube, 22 . . . tube spherical portion, 24, 26 . . . sealing portion, 28 . . . light emission portion, 30, 30b, 30c . . . reflector, 30ax, 30bax, 30cax . . . revolution center axis, 40, 40a, 40b, 40d . . . sub mirror, 42, 42b, 42d . . . reflection portion, 44, 44a, 44b, 44d . . . fixing portion, 45a . . . root end portion, 45b . . . tip portion, 45c . . . line, 46, 46a, 46b, 46d . . . connection portion, 48d . . . extended portion, 50 . . . tube-shaped member, 50a, 50b . . . tube-shaped portion, 50ax . . . axis of tube-shaped member, 52 . . . expanded portion, 54a, 54b . . . cut piece, 56 . . . end portion, 58 . . . sub mirror base material, 60 . . . reflection layer, 100 . . . illumination device, 100ax . . . illumination optical axis, 120 . . . first lens array, 122 . . . first small lens, 130 . . . second lens array, 132 . . . second small lens, 140 . . . polarization converting element, 150 . . . stacking lens, 200 . . . color separation light guide system, 210, 220 . . . dichroic mirror, 230, 240, 250 . . . reflection mirror, 260 . . . entrance side lens, 270 . . . relay lens, 300R, 300G, and 300B . . . converging lens, 400R, 400G, and 400B . . . liquid crystal device, 500 . . . cross dichroic prism, 600 . . . projection lens, 1000 . . . projector, c . . . cement, R1 . . . region containing expanded portion, L1, L2 . . . light, X1, X2, X3, X4 . . . cut, X1a, X2a . . . end, S . . . predetermined plane, SCR . . . screen

1. A light source device comprising:
an arc tube having a tube spherical portion containing a light emission portion and has a pair of sealing portions:
a reflector that is so shaped that at least an end on one side is removed in a cross-sectional view cut along a predetermined plane containing a revolution center axis and reflects light emitted from the light emission portion such that the light can travel toward a light receiving area; and
a sub mirror being disposed in such a condition as to cover the one side of the tube spherical portion and having a reflection portion and a fixing portion, the reflection portion that reflecting light emitted from the light emission portion such that the light can travel toward the light emission portion,
the fixing portion that fixes the sub mirror to the sealing portion by using an adhesive, and
the fixing portion being so constructed as to cover at least one of the pair of the sealing portions through an area larger than the half of the outer circumference of the corresponding sealing portion.

2. The light source device according to claim 1, wherein the fixing portion is fixed to the sealing portion by cement.

3. The light source device according to claim 1,
wherein a section of the fixing portion is fixed to the reflector by cement.

4. The light source device according to claim 1,
wherein the fixing portion is so constructed that the length of the fixing portion in the longitudinal direction of the sealing portion gradually decreases from the one side to the other side.

5. The light source device according to claim 1,
wherein the fixing portion covers the entire outer circumference of the sealing portion.

6. The light source device according to claim 1,
wherein the inner surface of the reflection portion has an aspherical shape and is so constructed that the light reflected by the reflection portion can travel toward the light emission portion.

7. A projector comprising:
an illumination device including the light source device according to claim 1;
an electro-optic modulation device that modulates illumination light emitted from the illumination device according to image information; and
a projection lens that projects modulation light received from the electro-optic modulation device.
